(19) United States
(12) Patent Application Publication
(10) Pub. No.: US 2015/0091952 A1
(43) Pub. Date: Apr. 2, 2015

(54) SUB-PIXEL DRIVING SYSTEM AND THE DRIVING METHOD THEREOF

(71) Applicant: INDUSTRIAL TECHNOLOGY RESEARCH INSTITUTE, Hsinchu (TW)

(72) Inventors: Sin-Huei WU, Nantou County (TW); Heng-Yin CHEN, Hsinchu County (TW); Yi-Ming ZHU, New Taipei City (TW); Sheng-Po WANG, Taoyuan County (TW)

(21) Appl. No.: 14/493,235

(22) Filed: Sep. 22, 2014

Related U.S. Application Data
(60) Provisional application No. 61/885,118, filed on Oct. 1, 2013.

(30) Foreign Application Priority Data
Jul. 18, 2014 (TW) 103124693

(51) Int. Cl. G09G 3/36

(52) U.S. Cl. CPC G09G 3/3607; G09G 3/3648; G09G 2330/021; G09G 2320/0653; G09G 2320/0666
USPC 345/690; 345/88

(57) ABSTRACT

An exemplary embodiment provides a sub-pixel driving system including a display panel, an image receiver, a control unit, an image-arrangement unit, and a driving unit. The display panel includes a plurality of pixels having a plurality of sub-pixels, wherein the display panel has a display characteristic. The image receiver receives a plurality of sub-pixel gradation signals. The control unit provides at least one driving parameter and determines a predetermined driving order, both according to the display characteristic. The image-arrangement unit arranges the sub-pixel gradation signals in a specific order according to the driving parameter. The driving unit drives the sub-pixels by the sub-pixel gradation signals that are arranged in the specific order according to the predetermined driving order.

### CROSS REFERENCE TO RELATED APPLICATIONS

This application claims the benefit of U.S. Provisional Application No. 61/885,118, filed on Oct. 1, 2013, the entirety of which is incorporated by reference herein. Furthermore, this Application claims priority of Taiwan Application No. 103124693, filed on Jul. 18, 2014, the entirety of which is incorporated by reference herein.

### BACKGROUND

1. Field

The exemplary embodiments relate to a sub-pixel driving system, and in particular to a sub-pixel driving system capable of determining the driving order.

2. Description of the Related Art

As flat panel TVs, smartphones and tablets become used more widely, a wide variety of the specifications and sizes of display panels (such as LED display panels and OLED display panels) are becoming more sophisticated to satisfy market demand. Thus, display panels have many faults that need to be solved. For example, as the resolution available on display panels gets upgraded, new innovative panels must be made. Therefore, effectively integrating different types of panels in the industry, and also reducing the power consumption of such panels, are issues that need to be resolved.

### BRIEF SUMMARY

A detailed description is given in the following embodiments with reference to the accompanying drawings.

An exemplary embodiment provides a sub-pixel driving system. The sub-pixel driving system includes a display panel, an image receiver, a control unit, an image-arrangement unit, and a driving unit. The display panel includes a plurality of pixels, wherein the display panel has a display characteristic, each of the pixels includes a plurality of sub-pixels, and the sub-pixels are arranged in a matrix with a plurality of rows and a plurality of columns. The image receiver is arranged to receive a plurality of sub-pixel gradation signals. The control unit provides at least one driving parameter and determines a predetermined driving order, both according to the display characteristic. The image-arrangement unit arranges the sub-pixel gradation signals received by the image receiver in a specific order according to the driving parameter. The driving unit is arranged to drive the sub-pixels of the display panel by the sub-pixel gradation signals arranged in the specific order according to the predetermined driving order.

Another exemplary embodiment provides a sub-pixel driving method, applied to a display panel including a sub-pixel driving system, wherein the display panel has a display characteristic and includes a plurality of pixels, each of the pixels includes a plurality of sub-pixels, and the sub-pixels are arranged in a matrix with a plurality of rows and a plurality of columns. The sub-pixel driving method includes: receiving a plurality of sub-pixel gradation signals; providing at least one driving parameter according to the display characteristic; arranging the received sub-pixel gradation signals according to the driving parameter; determining a predetermined driving order according to the display characteristic; and driving the sub-pixels of the display panel by the sub-pixel gradation signals arranged in a specific order according to the predetermined driving order.

### BRIEF DESCRIPTION OF THE DRAWINGS

The exemplary embodiments can be more fully understood by reading the subsequent detailed description and examples with references made to the accompanying drawings, wherein:

FIG. 1 is a schematic diagram illustrating an embodiment of a sub-pixel driving system of the present disclosure;

FIG. 2 is a schematic diagram illustrating an embodiment of pixels of the present disclosure;

FIG. 3 is a schematic diagram illustrating an embodiment of a display panel of the present disclosure;

FIG. 4 is a schematic diagram illustrating another embodiment of a display panel of the present disclosure;

FIG. 5 is a schematic diagram illustrating another embodiment of a display panel of the present disclosure;

FIG. 6 is a schematic diagram illustrating another embodiment of a display panel of the present disclosure;

FIG. 7 is a schematic diagram illustrating an embodiment of a driving unit of the present disclosure;

FIG. 8 is a schematic diagram illustrating another embodiment of a driving unit of the present disclosure;

FIG. 9 is a schematic diagram illustrating another embodiment of a sub-pixel driving system of the present disclosure;

FIG. 10 is a schematic diagram illustrating an embodiment of a storage device of the present disclosure;

FIG. 11 is a schematic diagram illustrating an embodiment of a plurality of driving signals of the present disclosure;

FIG. 12 is a schematic diagram illustrating another embodiment of a plurality of driving signals of the present disclosure;

FIG. 13 is a flowchart of a sub-pixel driving method according to an embodiment of the present disclosure;

FIG. 14 is a flowchart of line-buffer driving method of the sub-pixel driving method according to an embodiment of the present disclosure; and

FIG. 15 is a flowchart of line-buffer driving method of the sub-pixel driving method according to another embodiment of the present disclosure.

### DETAILED DESCRIPTION

The following description is of the best-contemplated mode of carrying out the exemplary embodiments. This description is made for the purpose of illustrating the general principles of the exemplary embodiments and should not be taken in a limiting sense. The scope of the exemplary embodiments is best determined by reference to the appended claims.

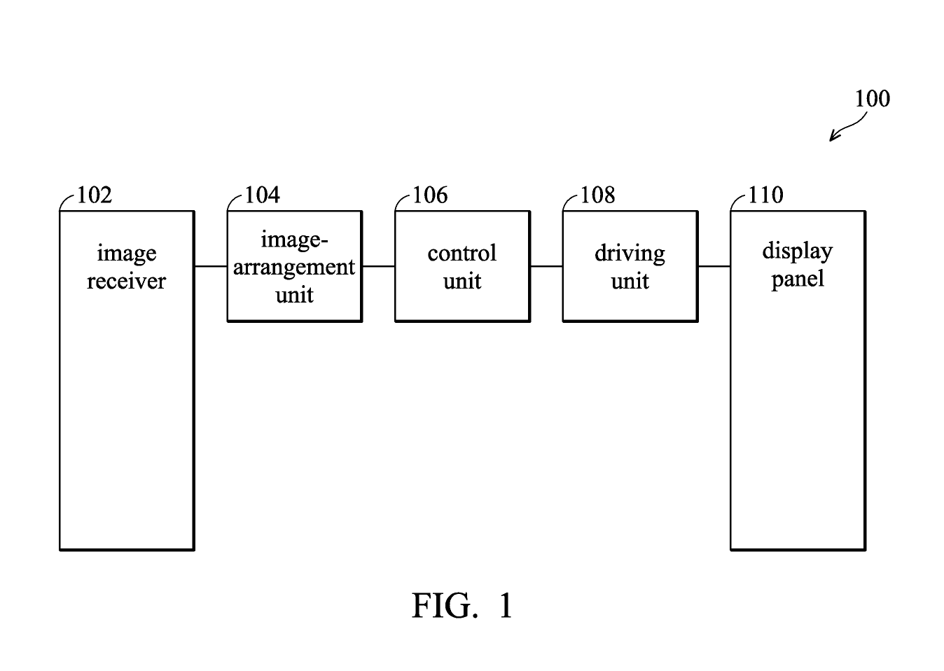

FIG. 1 is a schematic diagram illustrating an embodiment of a sub-pixel driving system of the present disclosure. The sub-pixel driving system 100 includes an image receiver 102, an image-arrangement unit 104, a control unit 106, a driving unit 108 and a display panel 110. Moreover, those skilled in the art will understand that the sub-pixel driving system 100 may be practiced with other computer-system configurations, including digital televisions, analog televisions, handheld devices, microprocessor-based or programmable consumer electronics, network PCs, minicomputers, mainframe computers, and the like. It should be noted that the sub-pixel driving system 100 can be implemented in an electronic device having a central processing unit (CPU) and a display module, wherein the display module includes another processor. In an embodiment, the image receiver 102 and the image-arrangement unit 104 are implemented in the central processing unit, and the control unit 106, the driving unit 108 and the display panel 110 are implemented in the processor of the display unit. Namely, the central processing unit may arrange the received sub-pixel gradation signals according to the driving parameter provided by the driving parameter, but it is not limited thereto. In another embodiment, the image receiver 102 is implemented in the central processing unit, and the image-arrangement unit 104, the control unit 106, the driving unit 108 and the display panel 110 are implemented in the processor of the display module.

The image receiver 102 is arranged to receive a plurality of sub-pixel gradation signals. For example, the image receiver 102 can be at least one data line arranged to receive sub-pixel gradation signals from the storage device, network or other sources. It should be noted that the sub-pixel gradation signals received by the image receiver 102 can constitute a frame, wherein the sub-pixel gradation signals include the gradation information of the red (R) sub-pixel, the green (G) sub-pixel and the blue (B) sub-pixel of each pixel.

The image-arrangement unit 104 is configured to arrange the sub-pixel gradation signals received by the image receiver 102 in a specific order according to the driving parameter produced by the control unit 106. For example, the image-arrangement unit 104 may rearrange the sub-pixel gradation signals according to the specific order of the sub-pixels of the display panel 110.

The control unit 106 is configured to determine a predetermined driving order according to the display characteristic of the display panel 110. Namely, the control unit 106 is configured to determine the predetermined driving order according to the voltages of the sub-pixels. In one embodiment, the predetermined driving order is arranged to drive the sub-pixels arranged in a matrix of the display panel 110 by row according to the voltage values applied to the sub-pixel. More specifically, the predetermined driving order is arranged to simultaneously drive the rows with similar voltage values at once. For example, the red sub-pixel, the green sub-pixel and the blue sub-pixel of each pixel is applied by the driving signals with different voltage values for producing various colors. However, the differences in voltage value between the sub-pixels with different primary colors are greater than the differences in voltage value between the sub-pixels with the same primary color. Therefore, the sub-pixels with the same primary color have similar voltage. In another embodiment, the control unit 106 is further configured to determine the predetermined driving order according to the sub-pixel gradation signals in each row. More specifically, the control unit 106 may calculate a plurality of averages of a plurality of voltage values by row of the sub-pixels applied by the sub-pixel gradation signals, respectively, and determine the predetermined driving order according to the averages, but it is not limited thereto. The control unit 106 may also calculate a plurality of averages of a plurality of voltage values of the sub-pixels applied by the sub-pixel gradation signals by row, respectively, and determine the predetermined driving order according to the averages. Furthermore, the averages are assigned to a plurality of ranges by value, and the control unit 106 is configured to drive the sub-pixels corresponding to the same range in one period of a plurality of periods. Moreover, the control unit 106 is further configured to provide at least one driving parameter and determine a predetermined driving order, both according to the display characteristic of the display panel 110, and transmit the driving parameter to the image-arrangement unit 104, such that the image-arrangement unit 104 may arrange the sub-pixel gradation signals received by the image receiver 102 into a specific order that meets the specification of the display panel 110 according to the driving parameter.

It should be noted that the control unit 106 provides the driving parameter or determines the predetermined driving order according to the external information. The external information can be a physical characteristic of the display panel 110, such that the control unit 106 may provide the driving parameter or determine the predetermined driving order according to the physical characteristic of the display panel 110, but it is not limited thereto. The physical characteristic includes at least one of deflection angle, ambient temperature, ambient humidity, surface temperature, surface humidity, ambient brightness, continuous use of time, the cumulative use of time, pressure and tilt angle of the display panel 110. In another embodiment, the control unit 106 may perform a statistical analysis on the sub-pixel gradation signals received by the image receiver 102 to determine the driving parameter or the predetermined driving order. The statistical analysis may include determining the distribution, the variance or the standard deviation of the color gradation of the sub-pixels with each color in each row or each column.

The driving unit 108 may use the sub-pixel gradation signals to drive the sub-pixels of the display panel 110 according to the predetermined driving order determined by the control unit 106. In one embodiment, the driving unit 108 uses the sub-pixel gradation signals arranged in the specific order by the image-arrangement unit 104 to drive the sub-pixels of the display panel 110.

The display panel 110 has a display characteristic. Furthermore, the display panel 110 includes a plurality of pixels, wherein each of the pixels has a plurality of sub-pixels, and the sub-pixels are arranged in a matrix with a plurality of rows and a plurality of columns. It should be noted that the sub-pixels of the display panel 110 are arranged in a specific arrangement structure. In this embodiment, the specific arrangement structure is the display characteristic. In the specific arrangement structure, any two adjacent pixels have at least two sub-pixels having the same primary color next to each other. It should be noted that the specific arrangement structure affects the order of voltages applied to the sub-pixels. In one embodiment, the control unit 106 is configured to determine the order of voltages applied to the sub-pixels according to the specific arrangement structure to determine the predetermined driving order, but it is not limited thereto. More specifically, the control unit 106 determines the predetermined driving order according to the order of the primary colors of the sub-pixels in the specific arrangement structure. For example, the predetermined driving order is driving the rows having sub-pixels with the same primary color in a period.

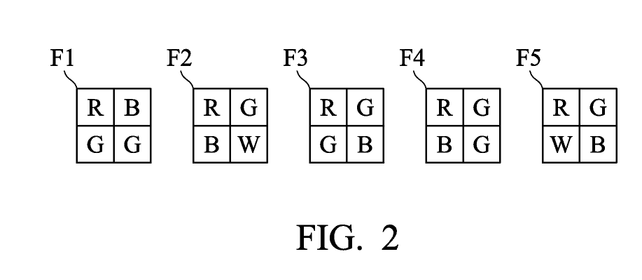

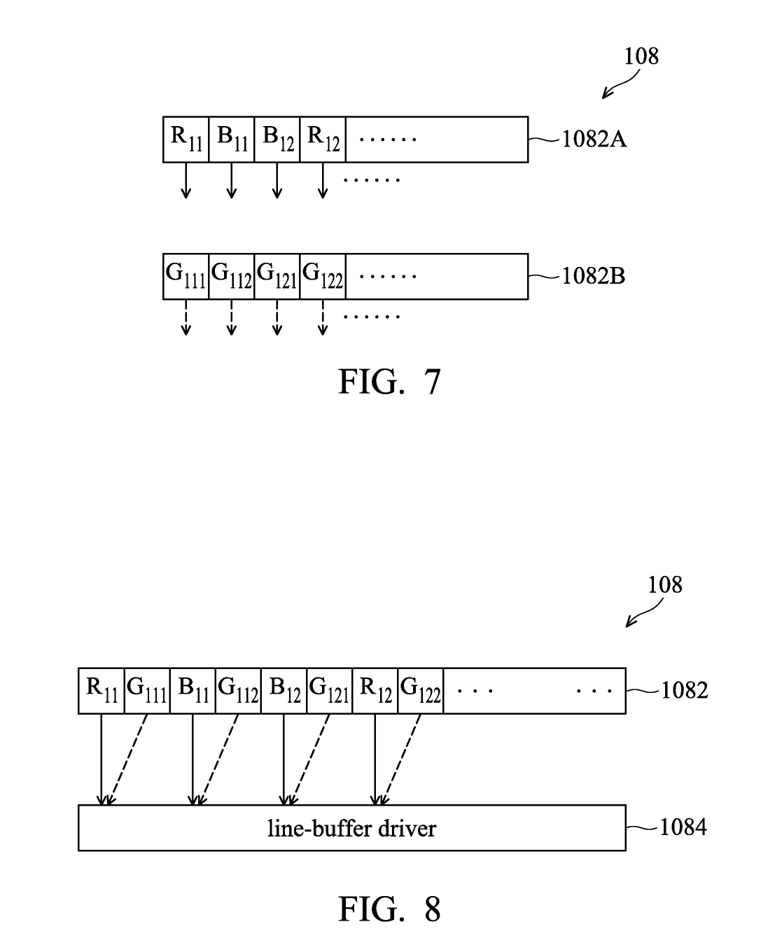

FIG. 2 is a schematic diagram illustrating an embodiment of pixels of the present disclosure. FIG. 2 shows the arrangement of the pixels F1˜F5 in five specific arrangement structures. It should be noted that the pixels F1˜F5 may form a display panel 110, as shown in FIG. 4 and FIG. 7. Each of the pixels F1˜F5 has four sub-pixels arranged in a four-square configuration, wherein the four-square configuration has a first row and a second row, each consisting of two of the sub-pixels. For example, the pixel F1 includes a red sub-pixel R, a blue sub-pixel B and two green sub-pixels G arranged in the four-square configuration, wherein the first row of the four-square configuration consists of the red sub-pixel R and the blue sub-pixel B, and the second row of the four-square configuration consists of the two green sub-pixels G. The pixel F2 includes a red sub-pixel R, a blue sub-pixel B, a green sub-pixel G and a white sub-pixel W arranged in the four-square configuration, wherein the first row of the four-square configuration consists of the red sub-pixel R and the green sub-pixel G, and the second row of the four-square configuration consists of the blue sub-pixel B and the white sub-pixel W. It should be noted that, in the embodiment of the pixel F2, the image-arrangement unit 104 calculates the sub-pixel gradation signals according to the driving parameter provided by the control unit 106 to determine the gradation of the white sub-pixel W. More specifically, the control unit 106 provides the driving parameter according to the display characteristic of the display panel 110. Namely, the control unit 106 provides the driving parameter according to the arrangement of the pixel F2. Furthermore, the image-arrangement unit 104 calculates the sub-pixel gradation signal of the white sub-pixel of each of the pixels according to the driving parameter. Next, the image-arrangement unit 104 arranges the sub-pixel gradation signals of red, blue, green and white according to the driving parameter corresponding to the specific arrangement structure of the display panel 110, but it is not limited thereto. Moreover, the pixel F3 includes a red sub-pixel R, a blue sub-pixel B and two green sub-pixels G arranged in the four-square configuration, wherein the first row of the four-square configuration consists of the red sub-pixel R and one of the green sub-pixels G, and the second row of the four-square configuration consists of another green sub-pixel G and the blue sub-pixel B. The pixel F4 includes a red sub-pixel R, a blue sub-pixel B and two green sub-pixels G arranged in the four-square configuration, wherein the first row of the four-square configuration consists of the red sub-pixel R and one of the green sub-pixels G, and the second row of the four-square configuration consists of the blue sub-pixel B and another green sub-pixel G. The pixel F5 includes a red sub-pixel R, a blue sub-pixel B, a green sub-pixel G and a white sub-pixel W arranged in the four-square configuration, wherein the first row of the four-square configuration consists of the red sub-pixel R and one of the green sub-pixels G, and the second row of the four-square configuration consists of the white sub-pixel W and the blue sub-pixel B.

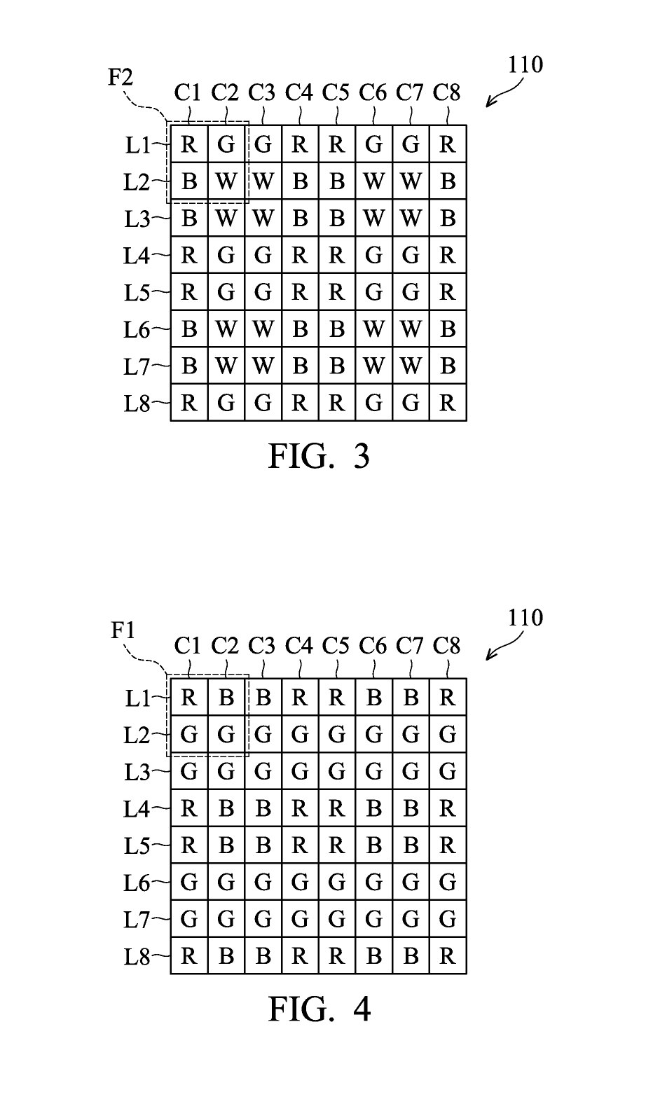

FIG. 3 is a schematic diagram illustrating an embodiment of a display panel of the present disclosure. The display panel 110 of FIG. 3 is constituted by the pixels F2. In this embodiment, the matrix of the display panel 110 has rows L1˜L8 and columns C1˜C8, wherein the resolution of the display panel 110 is 4×4, but it is not limited thereto. The resolution of the display panel 110 may be 800×450, 320×180, 640×360, 1,024×576, 1,280×720 or 4,096×2,304 pixels. As shown in FIG. 3, the specific arrangement structure of the display panel 110 is constituted by the pixels F2 arranged in the four-square configuration, and any two adjacent pixels in the specific arrangement structure have at least two sub-pixels having the same primary color next to each other.

FIG. 4 is a schematic diagram illustrating another embodiment of a display panel of the present disclosure. The display panel 110 of FIG. 4 is constituted by the specific arrangement structure of the pixel F1. In this embodiment, the matrix of the display panel 110 has rows L1˜L8 and columns C1˜C8, wherein the resolution of the display panel 110 is 4×4, but it is not limited thereto. The resolution of the display panel 110 may be 800×450, 320×180, 640×360, 1,024×576, 1,280×720 or 4,096×2,304 pixels. As shown in FIG. 4, the specific arrangement structure of the display panel 110 is constituted by the pixels F1 arranged in a four-square configuration, and any two adjacent pixels in the specific arrangement structure have at least two sub-pixels having the same primary color next to each other.

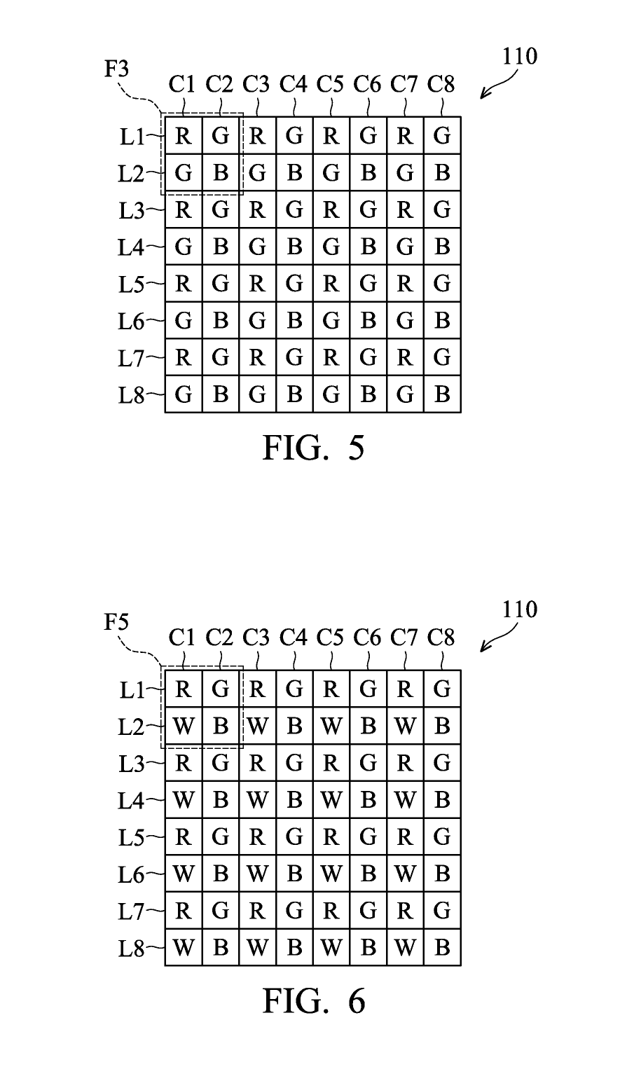

FIG. 5 is a schematic diagram illustrating another embodiment of a display panel of the present disclosure. The display panel 110 of FIG. 5 is constituted by the specific arrangement structure of the pixel F3. In this embodiment, the matrix of the display panel 110 has rows L1˜L8 and columns C1˜C8, wherein the resolution of the display panel 110 is 4×4, but it is not limited thereto. The resolution of the display panel 110 may be 800×450, 320×180, 640×360, 1,024×576, 1,280×720 or 4,096×2,304 pixels. As shown in FIG. 5, the specific arrangement structure of the display panel 110 is constituted by the pixels F3 arranged in a four-square configuration in non-mirror way, but it is not limited thereto. The specific arrangement structure constituted by the pixels F3 may also by constituted in the mirror way as shown in FIG. 3 and FIG. 4, such that any two adjacent pixels in the specific arrangement structure in the mirror way have at least two sub-pixels having the same primary color next to each other.

FIG. 6 is a schematic diagram illustrating another embodiment of a display panel of the present disclosure. The display panel 110 of FIG. 6 is constituted by the specific arrangement structure of the pixel F5. In this embodiment, the matrix of the display panel 110 has rows L1˜L8 and columns C1˜C8, wherein the resolution of the display panel 110 is 4×4, but it is not limited thereto. The resolution of the display panel 110 may be 800×450, 320×180, 640×360, 1,024×576, 1,280×720 or 4,096×2,304 pixels. As shown in FIG. 6, the specific arrangement structure of the display panel 110 is constituted by the pixels F5 arranged in the four-square configuration in non-mirror way, but it is not limited thereto. The specific arrangement structure constituted by the pixels F5 may also be constituted in the mirror way as shown in FIG. 3 and FIG. 4, such that any two adjacent pixels in the specific arrangement structure in the mirror way have at least two sub-pixels having the same primary color next to each other.

It should be noted that, in some embodiments, the driving unit 108 further includes a plurality of line buffers arranged to temporarily store the sub-pixel gradation signals arranged to apply to the pixels in sequence based on the specific arrangement structure for driving the display panel 110. For example, the driving unit 108 may include one line buffer, two line buffers, or three line buffers, but it is not limited thereto.

FIG. 7 is a schematic diagram illustrating an embodiment of a driving unit of the present disclosure. In this embodiment, the driving unit 108 further includes a first line buffer 1082A and a second line buffer 1082B. The first line buffer 1082A is arranged to temporarily store the sub-pixel gradation signals corresponding to the sub-pixels in the first row of the four-square configuration to drive the display panel 110. The second line buffer 1082B is arranged to temporarily store the sub-pixel gradation signals corresponding to the sub-pixels in the second row to drive the display panel 110. For example, the specific arrangement structure of the display panel 110 is constituted by the pixels F1 arranged in the four-square configuration, as shown in FIG. 4. The first line buffer 1082A is arranged to be filled by the sub-pixel gradation signals of the sub-pixels of rows L1, L4, L5 and L8, respectively. The second line buffer 1082B is arranged to be filled by the sub-pixel gradation signals of the sub-pixels of rows L2, L3, L6 and L7, respectively. As shown in FIG. 7, when the driving unit 108 is arranged to drive a row of the pixels constituted by the sub-pixels in row L1 and row L2, the first line buffer 1082A is arranged to be filled by the sub-pixel gradation signals R₁₁˜R₁₄ and B₁₁˜B₁₄ of the sub-pixels in row L1, wherein the sub-pixel gradation signal R₁₁ is arranged to drive the red sub-pixel R in row L1 and column C1, the sub-pixel gradation signal B₁₁ is arranged to drive the blue sub-pixel B in row L1 and column C2, the sub-pixel gradation signal B₁₂ is arranged to drive the blue sub-pixel B in row L1 and column C3, the sub-pixel gradation signal R₁₂ is arranged to drive the red sub-pixel R in row L1 and column C4, and so on. When the driving unit 108 is arranged to drive a row of the pixels constituted by the sub-pixels in row L1 and row L2, the second line buffer 1082B is arranged to be filled by the sub-pixel gradation signals G₁₁₁˜G₁₁₄ and G₁₂₁˜G₁₂₄ corresponding to the sub-pixels in row L2, wherein the sub-pixel gradation signal G₁₁₁ is arranged to drive the green sub-pixel G in row L2 and column C1, the sub-pixel gradation signal G₁₁₂ is arranged to drive the green sub-pixel G in row L2 and column C2, the sub-pixel gradation signal G₁₂₁ is arranged to drive the green sub-pixel G in row L2 and column C3, the sub-pixel gradation signal G₁₂₂ is arranged to drive the green sub-pixel G in row L2 and column C4, and so on, but it is not limited thereto. In another embodiment, the first line buffer 1082A and second line buffer 1082B may also drive the display panel 110 constituted by the pixel F2, F3, F4 or F5 according to the above rule.

FIG. 8 is a schematic diagram illustrating another embodiment of a driving unit of the present disclosure. In this embodiment, the driving unit 108 further includes a merge line buffer 1082 and a line-buffer driver 1084. The merge line buffer 1082 is arranged to temporarily store the sub-pixel gradation signals of a row of the sub-pixels constituted by the sub-pixels in the first row and the second row of the four-square configuration. The line-buffer driver 1084 is arranged to select the sub-pixel gradation signals corresponding to the first row of the sub-pixels arranged in the four-square configuration during a first period and select the sub-pixel gradation signals corresponding to the second row of the sub-pixels arranged in the four-square configuration during a second period from the merge line buffer 1082 for driving the display panel 110 by row. Namely, in this embodiment, the first line buffer 1082A and the second line buffer 1082B of FIG. 7 is merged into the merge line buffer 1082, and the line-buffer driver 1084 is arranged to select the sub-pixel gradation signals by row to drive the display panel 110 in sequence. For example, the specific arrangement structure of the display panel 110 is constituted by the four-square configuration with the pixel F1, as shown in FIG. 4. The merge line buffer 1082 is arranged to be filled by the sub-pixel gradation signals corresponding to a row of pixels constituted by two rows of the sub-pixels. As shown in FIG. 8, when the driving unit 108 is arranged to drive a row of pixels constituted by the sub-pixels in row L1 and row L2, the merge line buffer 1082 is arranged to be filled by the sub-pixel gradation signals R₁₁˜R₁₄, B₁₁˜B₁₄, G₁₁₁˜G₁₁₄ and G₁₂₁˜G₁₂₄ corresponding to the sub-pixels in row L1 and row L2, wherein the sub-pixel gradation signal R₁₁ is arranged to drive the red sub-pixel R in row L1 and column C1, the sub-pixel gradation signal G₁₁₁ is arranged to drive the green sub-pixel G in row L2 and column C1, the sub-pixel gradation signal B₁₁ is arranged to drive the blue sub-pixel B in row L1 and column C2, the sub-pixel gradation signal G₁₁₂ is arranged to drive the green sub-pixel G in row L2 and column C2, the sub-pixel gradation signal B₁₂ is arranged to drive the blue sub-pixel B in row L1 and column C3, the sub-pixel gradation signal G₁₂₁ is arranged to drive the green sub-pixel G in row L2 and column C3, the sub-pixel gradation signal R₁₂ is arranged to drive the red sub-pixel R in row L1 and column C4, the sub-pixel gradation signal G₁₂₂ is arranged to drive the green sub-pixel G in row L2 and column C4, and so on. Moreover, the line-buffer driver 1084 is arranged to select the sub-pixel gradation signals (R₁₁, B₁₁, B₁₂, R₁₂ . . . ) corresponding to the sub-pixels in row L1 from the merge line buffer 1082 during the first period for driving the sub-pixels in row L1, and select the sub-pixel gradation signals (G₁₁₁, G₁₁₂, G₁₂₁, G₁₂₂ . . . ) corresponding to the sub-pixels in row L2 from the merge line buffer 1082 during the second period for driving the sub-pixels in row L2. It should be noted that the first period and the second period are interwoven, but it is not limited thereto. In another embodiment, the merge line buffer 1082 and the line-buffer driver 1084 may also drive the display panel 110 constituted by the pixel F2, F3, F4 or F5 according to the above rule.

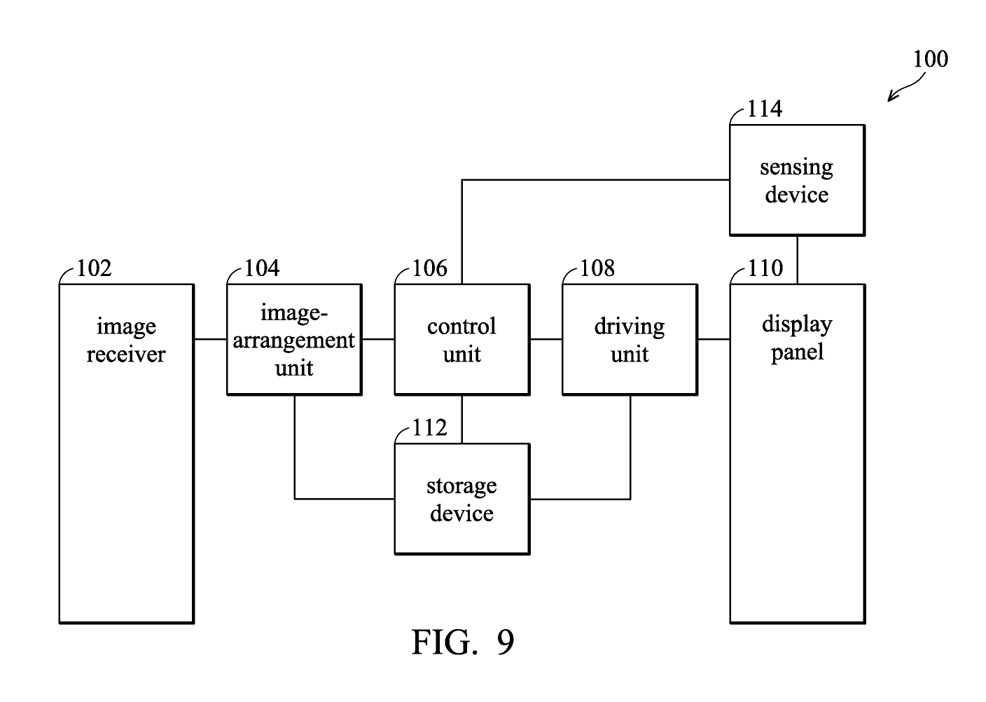

FIG. 9 is a schematic diagram illustrating another embodiment of a sub-pixel driving system of the present disclosure. The sub-pixel driving system 100 is similar to the sub-pixel driving system 100 of FIG. 1, except that the sub-pixel driving system 100 further includes a storage device 112 and a sensing device 114. Moreover, those skilled in the art will understand that the sub-pixel driving system 100 may be practiced with other computer-system configurations, including digital televisions, analog televisions, handheld devices, microprocessor-based or programmable consumer electronics, network PCs, minicomputers, mainframe computers, and the like. It should be noted that the sub-pixel driving system 100 can be implemented in an electronic device having a central processing unit (CPU) and a display module, wherein the display module includes another processor. In an embodiment, the image receiver 102, the image-arrangement unit 104 and the storage device 112 are implemented in the central processing unit, and the control unit 106, the control unit 106, the driving unit 108, the display panel 110 and the sensing device 114 are implemented in the processor of the display unit. Namely, the central processing unit may arrange the received sub-pixel gradation signals according to the driving parameter provided by the driving parameter, but it is not limited thereto. In another embodiment, the image receiver 102 is implemented in the central processing unit, and the image-arrangement unit 104, the control unit 106, the driving unit 108, the display panel 110, the storage device 112 and the sensing device 114 are implemented in the processor of the display module.

The storage device 112 includes a plurality of blocks arranged to store the sub-pixel gradation signals corresponding to the different primary colors. Namely, in this embodiment, the control unit 106 or the image-arrangement unit 104 is further arranged to store the sub-pixel gradation signals arranged in a specific order in the blocks, respectively, according to the primary colors of the sub-pixels. In other embodiments, the storage device 112 is further arranged to store the sub-pixel gradation signals arranged in a specific order in the blocks, respectively, according to the voltage values corresponding to the sub-pixel gradation signals, the panel structures of the display panel 110, the statistical analyses of the sub-pixel gradation signals of the display panel 110, or the physical characteristics of the display panel 110.

The sensing device 114 is arranged to detect the physical characteristic of the display panel 110, wherein the physical characteristic includes at least one of the deflection angle, ambient temperature, ambient humidity, surface temperature, surface humidity, ambient brightness, continuous use of time, the cumulative use of time, pressure and tilt angle of the display panel 110, but it is not limited thereto. For example, the sensing device 114 may include at least one of temperature sensing device, humidity sensing device, light sensing device, timing device, pressure sensing device and gravity sensing device, etc., but it is not limited thereto. In this embodiment, the control unit 106 may further configured to provide the driving parameter according to the physical characteristic of the display panel 110, and transmit the driving parameter corresponding to the physical characteristic of the display panel 110 to the image-arrangement unit 104. The image-arrangement unit 104 is configured to arrange the order of the sub-pixel gradation signals received by the image receiver 102 according to the driving parameter corresponding to the physical characteristic of the display panel 110.

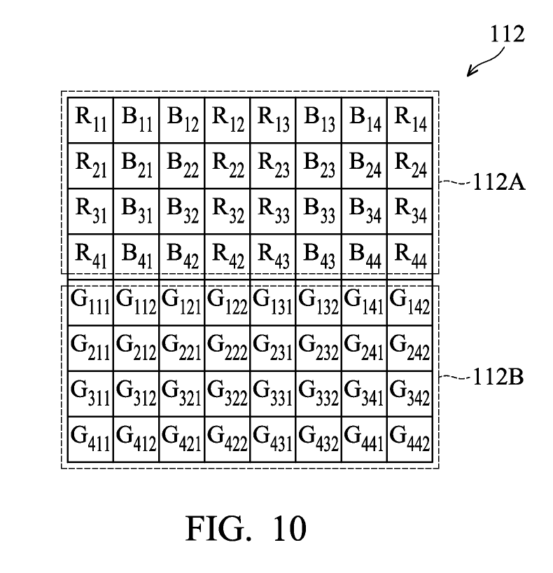

FIG. 10 is a schematic diagram illustrating an embodiment of a storage device of the present disclosure. In this embodiment, the storage device 112 has a block 112A and a block 112B arranged to store the sub-pixel gradation signals by colors according to the specific order. For example, the specific arrangement structure of the display panel 110 is constituted by the pixels F1 with the four-square configuration, as shown in FIG. 4. The block 112A is arranged to store the sub-pixel gradation signals of the sub-pixels in rows L1, L4, L5 and L8. The block 112B is arranged to store the sub-pixel gradation signals of the sub-pixels in rows L2, L3, L6 and L7, but it is not limited thereto.

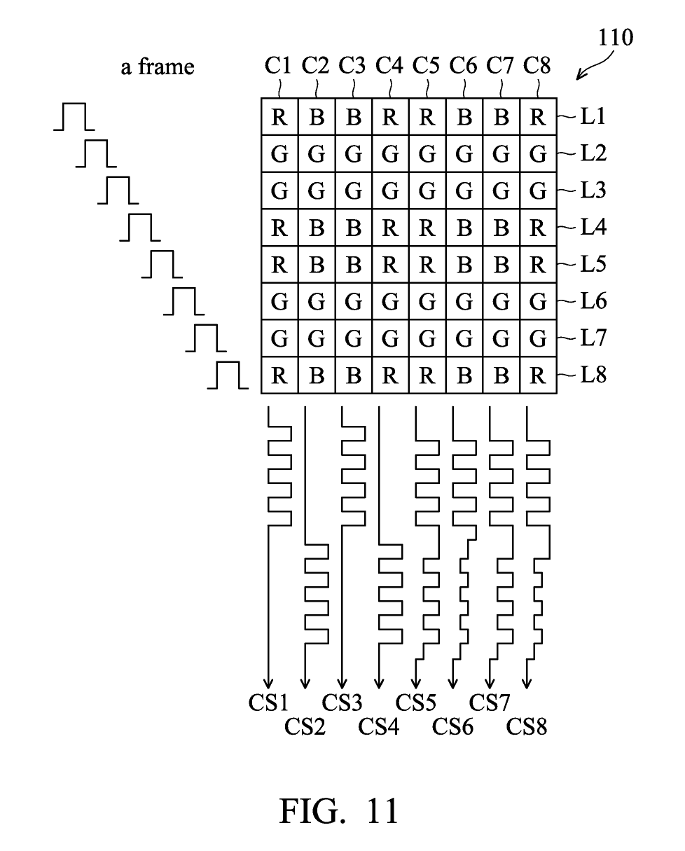

FIG. 11 is a schematic diagram illustrating an embodiment of a plurality of driving signals of the present disclosure. In this embodiment, the specific arrangement structure of the display panel 110 is constituted by the pixels F1 arranged in the four-square configuration, but it is not limited thereto. The driving unit 108 is arranged to use the sub-pixel gradation signals arranged in a specific order from top to bottom to drive the sub-pixels of the display panel 110 by row for displaying a frame. Namely, the driving unit 108 is arranged to drive the sub-pixel gradation signals corresponding to the rows L1, L2, L3 and L4, etc. The specific arrangement structure of the display panel 110 is constituted by the pixels F1 arranged in the four-square configuration. Each column of the matrix has the sub-pixels with different primary colors, such that the voltage difference of each of the driving signals CS1˜CS8 in each column varies greatly. Therefore, the sub-pixel driving system 100 requires a lot of power to operate.

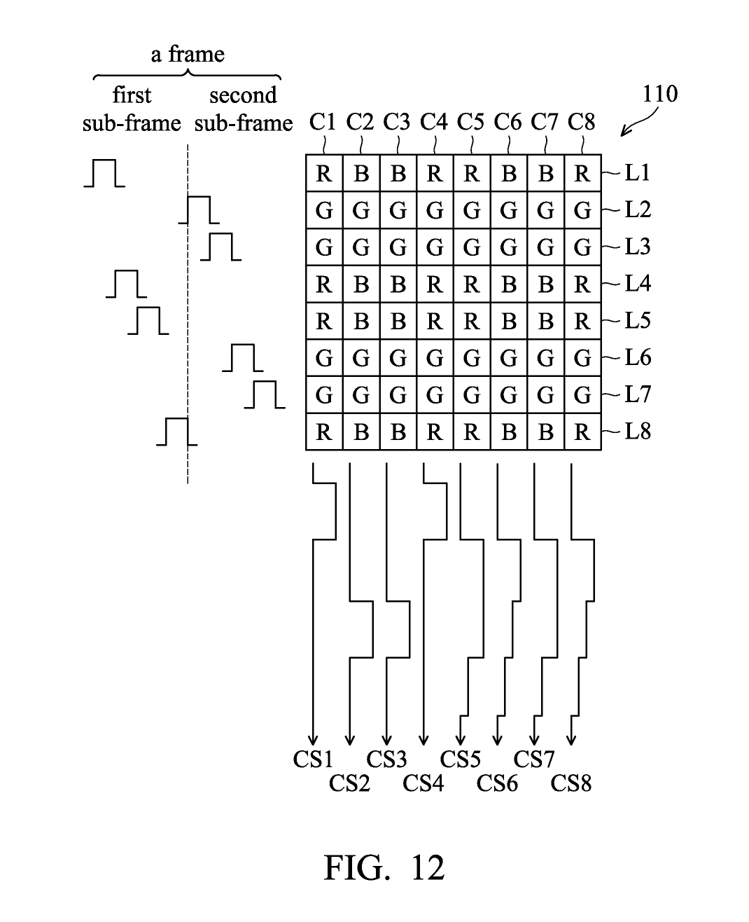

FIG. 12 is a schematic diagram illustrating another embodiment of a plurality of driving signals of the present disclosure. In this embodiment, the specific arrangement structure of the display panel 110 is constituted by the pixels F1 arranged in the four-square configuration, but it is not limited thereto. The driving unit 108 is arranged to drive the sub-pixels of the matrix according to the primary colors of the sub pixels twice, each time by a different color. As shown in FIG. 12, the sub-pixels of each of the columns C1˜C8 in the rows L1, L4, L5 and L8 have the same primary color, and the sub-pixels of each of the columns C1˜C8 in the rows L2, L3, L6 and L7 have the same primary color. Therefore, the control unit 106 uses the driving parameter to enable the driving unit 108 to drive a first sub-frame of a frame during a first period according to the display characteristic of the display panel 110. Next, during a second period, the control unit 106 uses the driving parameter to enable the driving unit 108 to drive a second sub-frame of the frame according to the display characteristic of the display panel 110. Namely, the driving unit 108 is arranged to use the sub-pixel gradation signals arranged in a specific order to drive the sub-pixels in the rows L1, L4, L5 and L8, first, and then drive the sub-pixels in the rows L2, L3, L6 and L7 to display a frame, wherein the sub-pixels with the same primary color are driven in the same period (the first period or the second period). The specific arrangement structure of the display panel 110 is constituted by the pixels F1 arranged in the four-square configuration, and the sub-pixels of each of the columns of the matrix are not the same. In one embodiment, the driving unit 108 drives the sub-pixels by row according to the colors, such that the differences between the voltage values of the driving signals CS1˜CS8 are decreased and the power consumption of the sub-pixel driving system 100 is also decreased.

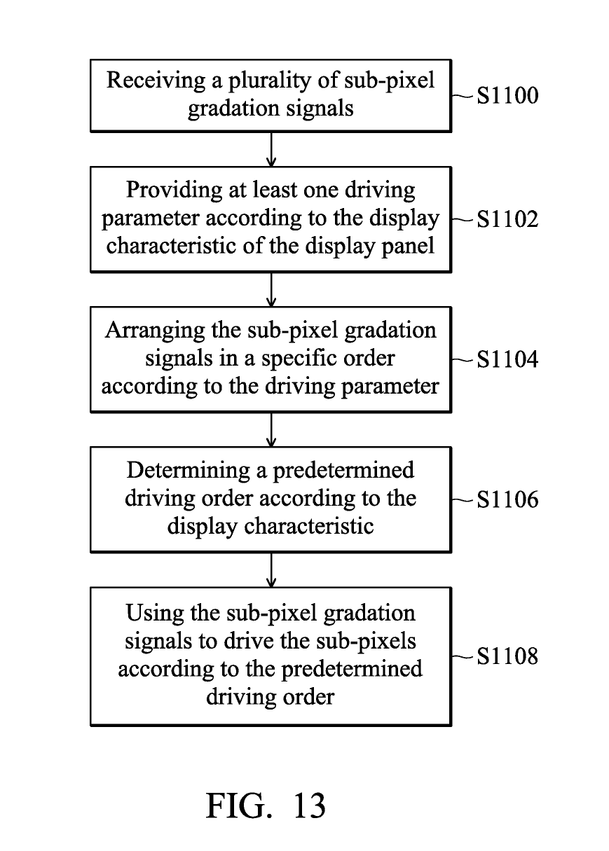

FIG. 13 is a flowchart of sub-pixel driving method according to an embodiment of the present disclosure. The sub-pixel driving method is applied to the sub-pixel driving system 100 having a display panel 110 of FIG. 1 and FIG. 9. The process starts at step S1100.

In step S1100, the image receiver 102 is arranged to receive a plurality of sub-pixel gradation signals. For example, the image receiver 102 can be at least one data line arranged to receive sub-pixel gradation signals from the storage device, network or other sources. It should be noted that the sub-pixel gradation signals received by the image receiver 102 can constitute a frame, wherein the sub-pixel gradation signals include the gradation information of the red (R) sub-pixel, the green (G) sub-pixel and the blue (B) sub-pixel of each pixel.

In step S1102, the control unit 106 is further configured to provide at least one driving parameter according to the display characteristic of the display panel 110. In the embodiment of FIG. 9, the control unit 106 is configured to provide the driving parameter according to the physical characteristic of the display panel 110 in step S1102, wherein the physical characteristic includes at least one of deflection angle, ambient temperature, ambient humidity, surface temperature, surface humidity, ambient brightness, continuous use of time, the cumulative use of time, pressure and tilt angle of the display panel 110. Furthermore, the physical characteristic of the display panel 110 may be detected by the sensing device 114.

It should be noted that the display panel 110 may further include a temporary storage unit arranged to store the physical characteristic of the display panel 110 for the control terminal (such as the control unit 106, or the processor of a cell phone or computer), such that the control terminal can adjust the physical characteristic.

Furthermore, in the step S1102, the control unit 106 is further configured to perform a statistical analysis on the sub-pixel gradation signals received by the image receiver 102 to determine the driving parameter or the predetermined driving order, wherein the control unit 106 further includes a frame analysis module (not shown) arranged to determine the distribution, the variance or the standard deviation of the color gradation of the sub-pixels with each color in each row or each column.

In step S1104, the image-arrangement unit 104 is configured to arrange the sub-pixel gradation signals received by the image receiver 102 in a specific order according to the driving parameter produced by the control unit 106. For example, the image-arrangement unit 104 may rearrange the sub-pixel gradation signals according to the specific order of the sub-pixels of the display panel 110. In another embodiment, the image-arrangement unit 104 may further arrange the sub-pixel gradation signals according to the physical characteristic of the display panel 110.

In step S1106, the control unit 106 is configured to determine a predetermined driving order according to the display characteristic of the display panel 110, wherein the control unit 106 is configured to determine the predetermined driving order according to the voltages of the sub-pixels. In one embodiment of the present disclosure, the predetermined driving order is arranged to drive the sub-pixels arranged in a matrix of the display panel 110 by row according to the voltage values applied to the sub-pixel. In this embodiment, the sub-pixels of the display panel 110 are arranged in a specific arrangement structure, and the specific arrangement structure is the display characteristic. In the specific arrangement structure, any two adjacent pixels have at least two sub-pixels having the same primary color next to each other. More specifically, in the specific arrangement structure, each pixel is constituted by the sub-pixels arranged in a four-square configuration, wherein the four-square configuration has a first row and a second row, each consisting of two of the sub-pixels. It should be noted that the specific arrangement structure affects the order of voltages applied to the sub-pixels. In one embodiment, the control unit 106 is configured to determine the order of voltages applied to the sub-pixels according to the specific arrangement structure to determine the predetermined driving order, but it is not limited thereto. More specifically, the control unit 106 determines the predetermined driving order according to the order of the primary colors of the sub-pixels in the specific arrangement structure. For example, the predetermined driving order is driving the rows having sub-pixels with the same primary color in a period.

In another embodiment, the control unit 106 is further configured to determine the predetermined driving order according to the sub-pixel gradation signals in each row. More specifically, the control unit 106 may calculate a plurality of averages of a plurality of voltage values by row of the sub-pixels applied by the sub-pixel gradation signals, respectively, and determine the predetermined driving order according to the averages, but it is not limited thereto. The control unit 106 may also calculate a plurality of averages of a plurality of voltage values of the sub-pixels applied by the sub-pixel gradation signals by row, respectively, and determine the predetermined driving order according to the averages.

In step S1108, the driving unit 108 is configured to use the sub-pixel gradation signals to drive the sub-pixels of the display panel 110 according to the predetermined driving order determined by the control unit 106. In one embodiment, the driving unit 108 uses the sub-pixel gradation signals arranged in a specific order by the image-arrangement unit 104 to drive the sub-pixels of the display panel 110. The process ends at step S1108.

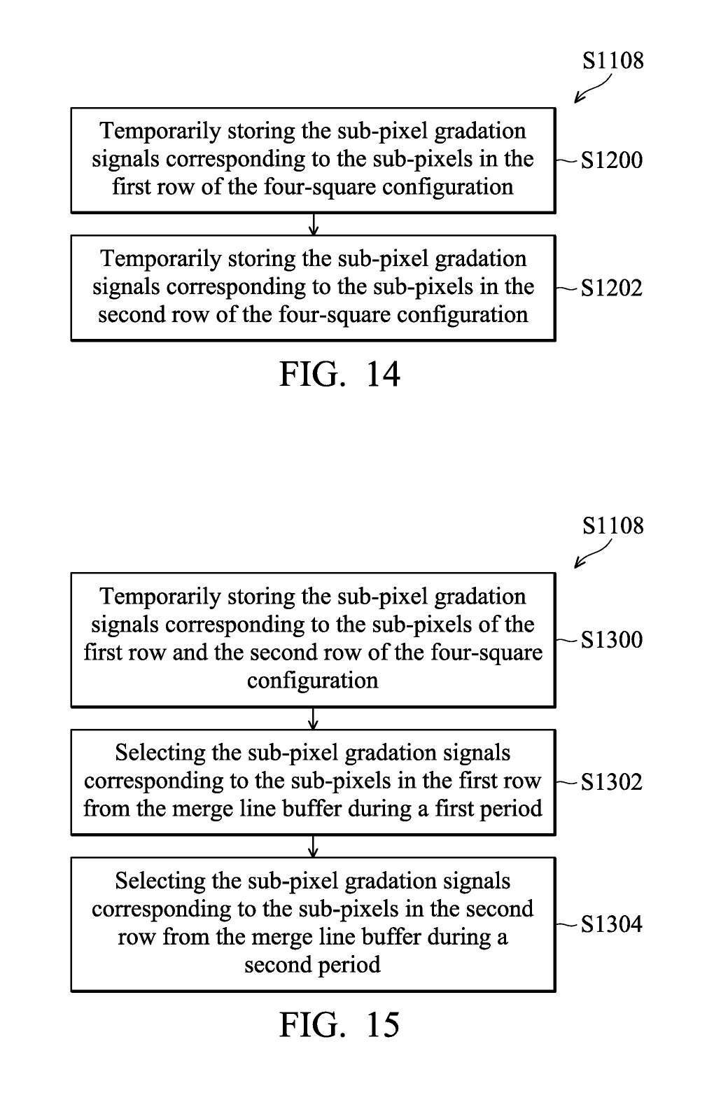

FIG. 14 is a flowchart of line-buffer driving method of the sub-pixel driving method according to an embodiment of the present disclosure. The line-buffer driving method is applied to the step S1108 of the sub-pixel driving method. In the step S1108 of FIG. 13, the driving unit 108 is further arranged to drive the sub-pixels of the display panel 110 according to the line-buffer driving method of FIG. 14. The process starts at step S1200.

In step S1200, the driving unit 108 is arranged to temporarily store the sub-pixel gradation signals corresponding to the sub-pixels in the first row of the four-square configuration for driving the display panel 110. As shown in FIG. 7, the first line buffer 1082A is arranged to be filled by the sub-pixel gradation signals of the sub-pixels of rows L1, L4, L5 and L8, respectively. For example, when the driving unit 108 is arranged to drive a row of the pixels constituted by the sub-pixels in row L1 and row L2, the first line buffer 1082A is arranged to be filled by the sub-pixel gradation signals R₁₁˜R₁₄ and B11˜B14 of the sub-pixels in row L1, wherein the sub-pixel gradation signal R₁₁ is arranged to drive the red sub-pixel R in row L1 and column C1, the sub-pixel gradation signal B₁₁ is arranged to drive the blue sub-pixel B in row L1 and column C2, the sub-pixel gradation signal B₁₂ is arranged to drive the blue sub-pixel B in row L1 and column C3, the sub-pixel gradation signal R₁₂ is arranged to drive the red sub-pixel R in row L1 and column C4, and so on.

In step S1202, the driving unit 108 is arranged to temporarily store the sub-pixel gradation signals corresponding to the sub-pixels in the second row of the four-square configuration for driving the display panel 110. As shown in FIG. 7, the second line buffer 1082B is arranged to be filled by the sub-pixel gradation signals of the sub-pixels of rows L2, L3, L6 and L7, respectively. For example, when the driving unit 108 is arranged to drive a row of the pixels constituted by the sub-pixels in row L1 and row L2, the second line buffer 1082B is arranged to be filled by the sub-pixel gradation signals G₁₁₁˜G₁₁₄ and G₁₂₁˜G₁₂₄ corresponding to the sub-pixels in row L2, wherein the sub-pixel gradation signal G₁₁₁ is arranged to drive the green sub-pixel G in row L2 and column C1, the sub-pixel gradation signal G₁₁₂ is arranged to drive the green sub-pixel G in row L2 and column C2, the sub-pixel gradation signal G₁₂₁ is arranged to drive the green sub-pixel G in row L2 and column C3, the sub-pixel gradation signal G₁₂₂ is arranged to drive the green sub-pixel G in row L2 and column C4, and so on. The process ends at step S1202.

FIG. 15 is a flowchart of line-buffer driving method of the sub-pixel driving method according to another embodiment of the present disclosure. The line-buffer driving method is applied to the step S1108 of the sub-pixel driving method. In the step S1108 of FIG. 13, the driving unit 108 is further arranged to drive the sub-pixels of the display panel 110 according to the line-buffer driving method of FIG. 15. The process starts at step S1300.

In step S1300, the driving unit 108 is arranged to temporarily store the sub-pixel gradation signals corresponding to the sub-pixels of the first row and the second row of the four-square configuration, as shown in FIG. 8. When the driving unit 108 is arranged to drive a row of pixels constituted by the sub-pixels in row L1 and row L2, the merge line buffer 1082 is arranged to be filled by the sub-pixel gradation signals R₁₁˜R₁₄, B₁₁˜B₁₄, G₁₁₁˜G₁₁₄ and G₁₂₁˜G₁₂₄ corresponding to the sub-pixels in row L1 and row L2, wherein the sub-pixel gradation signal R₁₁ is arranged to drive the red sub-pixel R in row L1 and column C1, the sub-pixel gradation signal G₁₁₁ is arranged to drive the green sub-pixel G in row L2 and column C1, the sub-pixel gradation signal B₁₁ is arranged to drive the blue sub-pixel B in row L1 and column C2, the sub-pixel gradation signal G₁₁₂ is arranged to drive the green sub-pixel G in row L2 and column C2, the sub-pixel gradation signal B₁₂ is arranged to drive the blue sub-pixel B in row L1 and column C3, the sub-pixel gradation signal G₁₂₁ is arranged to drive the green sub-pixel G in row L2 and column C3, the sub-pixel gradation signal R₁₂ is arranged to drive the red sub-pixel R in row L1 and column C4, the sub-pixel gradation signal G₁₂₂ is arranged to drive the green sub-pixel G in row L2 and column C4, and so on.

In step S1302, the line-buffer driver 1084 is arranged to select the sub-pixel gradation signals corresponding to the sub-pixels in row L1 from the merge-line buffer 1082 during the first period for driving the display panel 110. Namely, as shown in FIG. 8, the line-buffer driver 1084 is arranged to select the sub-pixel gradation signals (R₁₁, B₁₁, B₁₂, R₁₂ . . . ) corresponding to the sub-pixels in row L1 from the merge line buffer 1082 during the first period for driving the sub-pixels in row L1.

In step S1304, the line-buffer driver 1084 is arranged to select the sub-pixel gradation signals corresponding to the sub-pixels in row L2 from the merge line buffer 1082 during the second period for driving the display panel 110. Namely, as shown in FIG. 8, line-buffer driver 1084 is arranged to select the sub-pixel gradation signals (G₁₁₁, G₁₁₂, G₁₂₁, G₁₂₂ . . . ) corresponding to the sub-pixels in row L2 from the merge-line buffer 1082 during the second period for driving the sub-pixels in row L2 during the second period. It should be noted that the first period and the second period are interwoven. The process ends at step S1304.

The sub-pixel driving system 100 and the sub-pixel driving method may determine the driving order of the sub-pixels of the display panel 110 by row according to the color or average of voltages which may affect the variation of the driving signals.

Data transmission methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

While the exemplary embodiments have been described by way of example and in terms of the preferred embodiments, it is to be understood that the exemplary embodiments are not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sub-pixel driving system, comprising:
a display panel, comprising a plurality of pixels, wherein the display panel has a display characteristic, each of the pixels comprise a plurality of sub-pixels, and the sub-pixels are arranged in a matrix with a plurality of rows and a plurality of columns;
an image receiver, arranged to receive a plurality of sub-pixel gradation signals;
a control unit, providing at least one driving parameter and determining a predetermined driving order, both according to the display characteristic;
an image-arrangement unit, arranging the sub-pixel gradation signals received by the image receiver in a specific order according to the driving parameter;
a driving unit, arranged to drive the sub-pixels of the display panel by the sub-pixel gradation signals arranged in the specific order according to the predetermined driving order.

2. The sub-pixel driving system as claimed in claim 1, wherein the sub-pixels of the display panel are arranged in a specific arrangement structure, and the display characteristic includes the specific arrangement structure, wherein any two adjacent pixels in the specific arrangement structure have at least two sub-pixels having the same primary color next to each other.

3. The sub-pixel driving system as claimed in claim 2, wherein the control unit determines a plurality of voltage values applied to the sub-pixels, respectively, according to the specific arrangement structure for determining the predetermined driving order.

4. The sub-pixel driving system as claimed in claim 2, wherein the control unit determines the predetermined driving order according to an order of the primary colors of the sub-pixels in the specific arrangement structure, wherein the control unit is further configured to enable the driving unit to drive a first sub-frame during a first period and a second sub-frame of a frame during a second period, according to the specific arrangement structure, wherein the sub-pixels with the same primary color are driven during the first period or the second period.

5. The sub-pixel driving system as claimed in claim 1, wherein the control unit is further configured to respectively calculate a plurality of averages of a plurality of voltage values by row of the sub-pixels applied by the sub-pixel gradation signals, and determine the predetermined driving order according to the averages, wherein the averages are assigned to a plurality of ranges by value, and the control unit is arranged to drive the sub-pixels corresponding to the same range in one period of a plurality of periods.

6. The sub-pixel driving system as claimed in claim 2, wherein the driving unit further comprises a plurality of line buffers arranged to temporarily store the sub-pixel gradation signals arranged to apply to the sub-pixels in sequence based on the specific arrangement structure for driving the display panel.

7. The sub-pixel driving system as claimed in claim 2, wherein each of the pixels is constituted by the sub-pixels arranged in a four-square configuration in the specific arrangement structure, wherein the four-square configuration has a first row and a second row, each consisting of two of the sub-pixels.

8. The sub-pixel driving system as claimed in claim 7, wherein the driving unit further comprises:
a merge line buffer, arranged to temporarily store the sub-pixel gradation signals corresponding to the sub-pixels in the first row and the second row of the four-square configuration; and
a line-buffer driver, configured to select the sub-pixel gradation signals corresponding to the sub-pixels in the first row of the four-square configuration for driving the display panel during a first period, and select the sub-pixel gradation signals corresponding to the sub-pixels in the second row of the four-square configuration for driving the display panel during a second period.

9. The sub-pixel driving system as claimed in claim 1, further comprising a storage device which comprises a plurality of blocks, wherein the control unit is further arranged to respectively store the sub-pixel gradation signals arranged in the specific order in the blocks according to color, voltage, panel structure, statistical analysis of the sub-pixel gradation signal, or physical characteristics of the display panel.

10. The sub-pixel driving system as claimed in claim 1, wherein the control unit is further configured to provide the driving parameter according to a physical characteristic of the display panel, wherein the physical characteristic comprises at least one of deflection angle, cumulative use-time, pressure and tilt angle of the display panel.

11. A sub-pixel driving method, applied to a display panel comprising a sub-pixel driving system, wherein the display panel has a display characteristic and comprises a plurality of pixels, each of the pixels comprise a plurality of sub-pixels, and the sub-pixels are arranged in a matrix with a plurality of rows and a plurality of columns, the sub-pixel driving method comprising:
receiving a plurality of sub-pixel gradation signals;
providing at least one driving parameter according to the display characteristic;
arranging the received sub-pixel gradation signals in a specific order according to the driving parameter;
determining a predetermined driving order according to the display characteristic; and
driving the sub-pixels of the display panel by the sub-pixel gradation signals arranged in the specific order according to the predetermined driving order.

12. The sub-pixel driving method as claimed in claim 11, wherein the sub-pixels of the display panel are arranged in a specific arrangement structure, and the display characteristic includes the specific arrangement structure, wherein any two adjacent pixels in the specific arrangement structure have at least two sub-pixels having the same primary color next to each other.

13. The sub-pixel driving method as claimed in claim 12, wherein the step of determining the predetermined driving order according to the display characteristic comprises:
determining a plurality of voltage values applied to the sub-pixels, respectively, according to the specific arrangement structure for determining the predetermined driving order.

14. The sub-pixel driving method as claimed in claim 12, wherein the step of determining the predetermined driving order according to the display characteristic comprises:
determining the predetermined driving order according to an order of the primary colors of the sub-pixels in the specific arrangement structure, wherein a first sub-frame and a second sub-frame of a frame are driven during a first period and a second period, respectively, according to the specific arrangement structure, and the sub-pixels with the same primary color are driven during the first period or the second period.

15. The sub-pixel driving method as claimed in claim 11, wherein the step of determining the predetermined driving order according to the display characteristic comprises:
calculating a plurality of averages of a plurality of voltage values by row of the sub-pixels applied by the sub-pixel gradation signals; and
determining the predetermined driving order according to the averages, wherein the averages are assigned to a plurality of ranges by value, wherein the sub-pixels corresponding to the same range are driven in one period of a plurality of periods.

16. The sub-pixel driving method as claimed in claim 12, wherein the step of driving the sub-pixels of the display panel by the sub-pixel gradation signals arranged in a specific order according to the predetermined driving order further comprises:
temporarily storing the sub-pixel gradation signals arranged to apply to the sub-pixels in sequence based on the specific arrangement structure by a plurality of line buffers for driving the display panel.

17. The sub-pixel driving method as claimed in claim 12, wherein each of the pixels is constituted by the sub-pixels arranged in a four-square configuration in the specific arrangement structure, wherein the four-square configuration has a first row and a second row, each consisting of two of the sub-pixels.

18. The sub-pixel driving method as claimed in claim 17, wherein the step of driving the sub-pixels of the display panel by the sub-pixel gradation signals arranged in a specific order according to the predetermined driving order further comprises:
temporarily storing the sub-pixel gradation signals corresponding to the sub-pixels in the first row and the second row of the four-square configuration in a merge line buffer;
selecting the sub-pixel gradation signals corresponding to the sub-pixels in the first row of the four-square configuration for driving the display panel during a first period; and
selecting the sub-pixel gradation signals corresponding to the sub-pixels in the second row of the four-square configuration for driving the display panel during a second period.

19. The sub-pixel driving method as claimed in claim 11, further comprising: storing the sub-pixel gradation signals arranged in the specific order in a plurality of blocks of a storage device, respectively, according to color, voltage, panel structure, statistical analysis of the sub-pixel gradation signal, or physical characteristics of the display panel.

20. The sub-pixel driving method as claimed in claim 11, wherein the step of providing the driving parameter according to the display characteristic further comprises:
providing the driving parameter according to a physical characteristic of the display panel, wherein the physical characteristic comprises deflection angle, cumulative use-time, pressure and/or tilt angle of the display panel.
